(19) United States
(12) Patent Application Publication
(10) Pub. No.: US 2013/0174097 A1
(43) Pub. Date: Jul. 4, 2013

(54) CO-LOCATED USER INTERFACE CONTROLS

(71) Applicant: Gregg Wernecke, La Crescent, MN (US)

(72) Inventor: Gregg Wernecke, La Crescent, MN (US)

(21) Appl. No.: 13/339,663

(22) Filed: Dec. 29, 2011

(51) Int. Cl. G06F 3/048

(52) U.S. Cl. 715/846

(57) ABSTRACT

A system may include presentation of a plurality of shapes on a display, each shape associated with a selection value and one or more of the plurality of shapes being circumscribed by one or more other of the plurality of shapes, reception of a selection of one of the plurality of shapes, and, in response to receipt of the selection, presentation of a graphical indication of the selection of the one of the plurality of shapes.

### FIELD

Some embodiments relate to user interfaces. More particularly, some embodiments relate to user interface controls for inputting or reviewing a selection of a value.

### BACKGROUND

Computing systems employ user interfaces to present information to and receive input from users. A user interface typically includes user interface controls which may be manipulated by a user to set values, adjust values and/or control an application. User interface controls are typically grouped according to function or according to the object upon which they operate.

The layout of user interface controls within a user interface is often problematic. First, a user interface includes a limited amount of space in which to position the user interface controls. Also, in order to allow a user to easily distinguish one from another, user interface controls are usually spaced a significant distance apart from one another.

Systems are desired to provide intuitive user interface controls which provide desired functionality within a smaller user interface area than conventional systems.

### BRIEF DESCRIPTION OF THE DRAWINGS

FIG. 1 is a view of a user interface according to some embodiments.

FIG. 2 is a flow diagram of a process according to some embodiments.

FIG. 3 is a view of a user interface according to some embodiments.

FIG. 4 is a view of a user interface according to some embodiments.

FIG. 5 is a view of a user interface according to some embodiments.

FIG. 6 is a view of a user interface according to some embodiments.

FIG. 7 is a view of a user interface according to some embodiments.

FIG. 8 is a view of a user interface according to some embodiments.

FIG. 9 is a block diagram of a computing device according to some embodiments.

### DETAILED DESCRIPTION

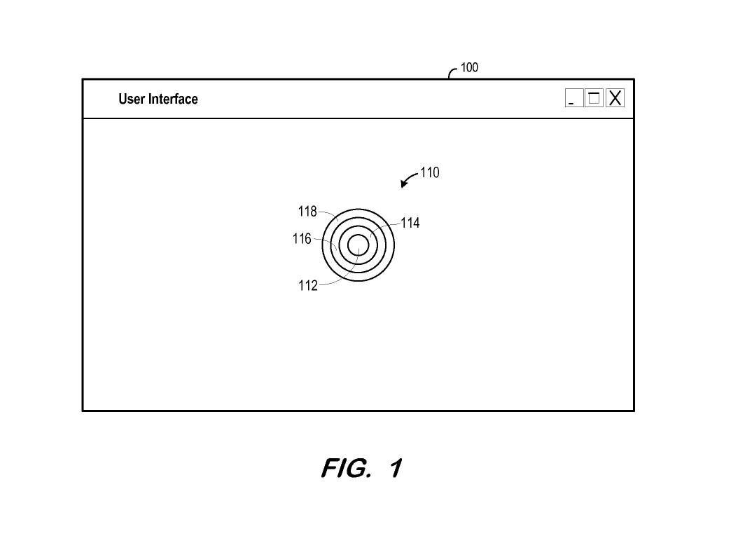

FIG. 1 depicts user interface 100 as presented according to some embodiments. User interface 100 includes user interface control 110. User interface control 110 comprises shapes 112, 114, 116 and 118. Each of shapes 112, 114, 116 and 118 defines a circle, but embodiments are not limited thereto. Without loss of generality the circles of all but the innermost shape could be described as rings.

Shape 112 is circumscribed by shapes 114, 116 and 118. Similarly, shape 114 is circumscribed by shapes 116 and 118, and shape 116 is circumscribed by shape 118. Shapes 112, 114, 116 and 118 of user interface control are concentric, but, again, embodiments are not limited thereto. In some embodiments, the circles are eccentric and touch at a common point on the outer circle 118.

In some embodiments, one or more of shapes 112, 114, 116 and 118 appears three-dimensional (e.g., a plurality of concentric spheres). Each of shapes 112, 114, 116 and 118 need not be identical in shape (i.e., the plurality of shapes may comprise, for example, a mix of polygons and circles). According to some embodiments, each of shapes 112, 114, 116 and 118 may be selected from: oval, ellipse, straight sides with semi-circular ends, polygon, and the like.

User interface control 110 provides an advantageous combination of function and footprint. Specifically, each of shapes 112, 114, 116 and 118 is associated with a respective selection value. A selection value is a discrete value in a set of values. Accordingly, a selection of one of shapes 112, 114, 116 and 118 may be interpreted as a selection of its associated selection value. Review of the user interface control 110 by the user leads to the same interpretation. Examples of the foregoing according to some embodiments are described below.

Prior to describing the examples, it is noted that user interface 100 comprises an operating system “window”, but embodiments are not limited thereto. User interface 100 may comprise any graphical element for presenting a user interface control. User interface 100 may comprise a user interface of a standalone application (e.g., a word processing application, a design application, an analytical application) and may therefore be presented on a display of a computing device including a memory to store program code of such an application and a processor to execute the program code. In some embodiments, user interface 100 is a main window of a Web browser and user interface control 110 is an element of a Web page displayed therein.

Examples of a computing device to present user interface control 110 include, but are not limited to, desktop computers, laptop computers, personal digital assistants, tablet PCs, and smartphones.

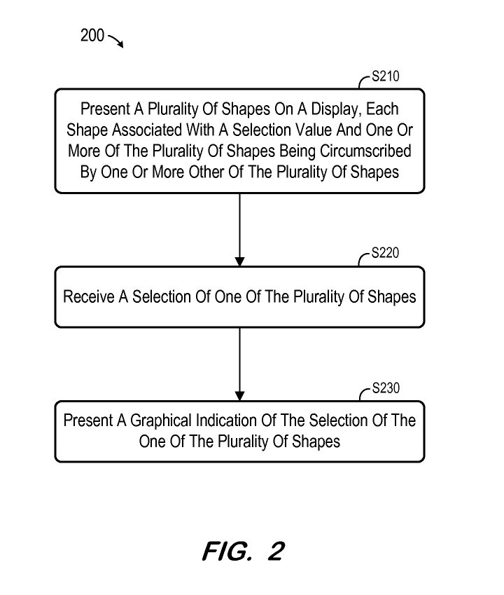

FIG. 2 comprises a flow diagram of process 200 according to some embodiments. In some embodiments, various hardware elements of a computing device execute program code to perform process 200. In some embodiments, hard-wired circuitry may be used in place of, or in combination with, program code for implementation of processes according to some embodiments. Embodiments are therefore not limited to any specific combination of hardware and software.

Prior to S210, an instruction to present a user interface is received. The instruction may be received from a user (e.g., an instruction to invoke an application, an instruction to configure application settings, etc.) or may result from an external event (e.g., a software-triggered alert or notification).

Initially, at S210, a plurality of shapes are presented on a display. Each shape is associated with a selection value and one or more of the plurality of shapes is circumscribed by one or more other of the plurality of shapes. As described above, user interface control 110 of user interface 100 provides an example of a plurality of shapes according to S210.

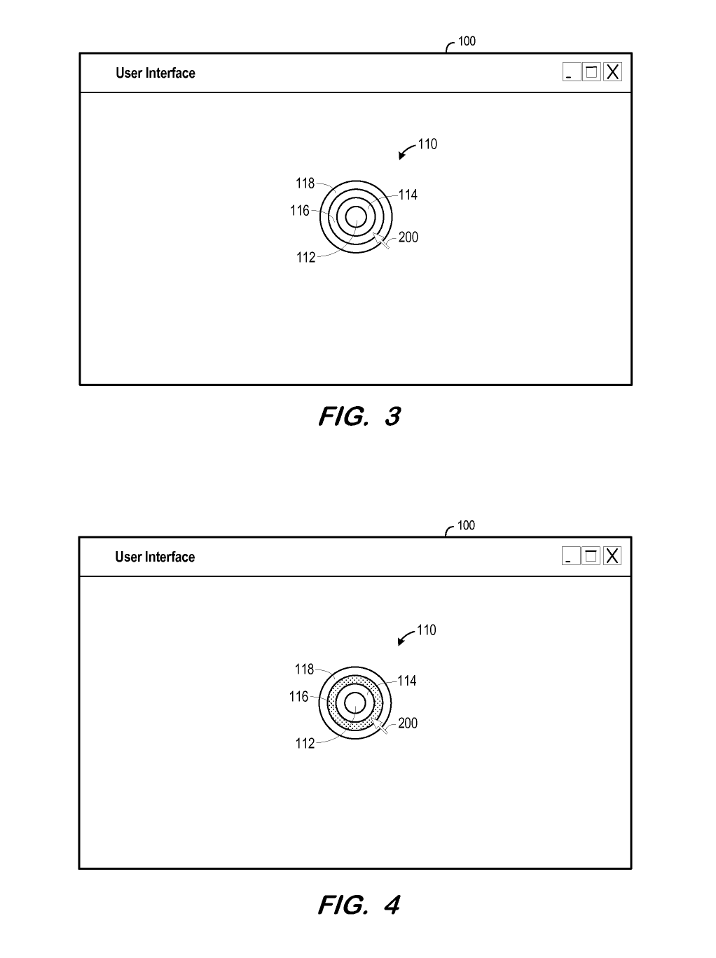

Next, at S220, a selection of one of the plurality of shapes is received. FIG. 3 illustrates a selection that is received at S220 according to some embodiments. As shown, a user has operated an input device (e.g., mouse, trackball, touchscreen, etc.) to position a tip of arrow 200 on shape 116. According to the present example, the user then indicates a selection using an appropriate action (e.g., mouse click, tap, etc.). The selection is received at S220.

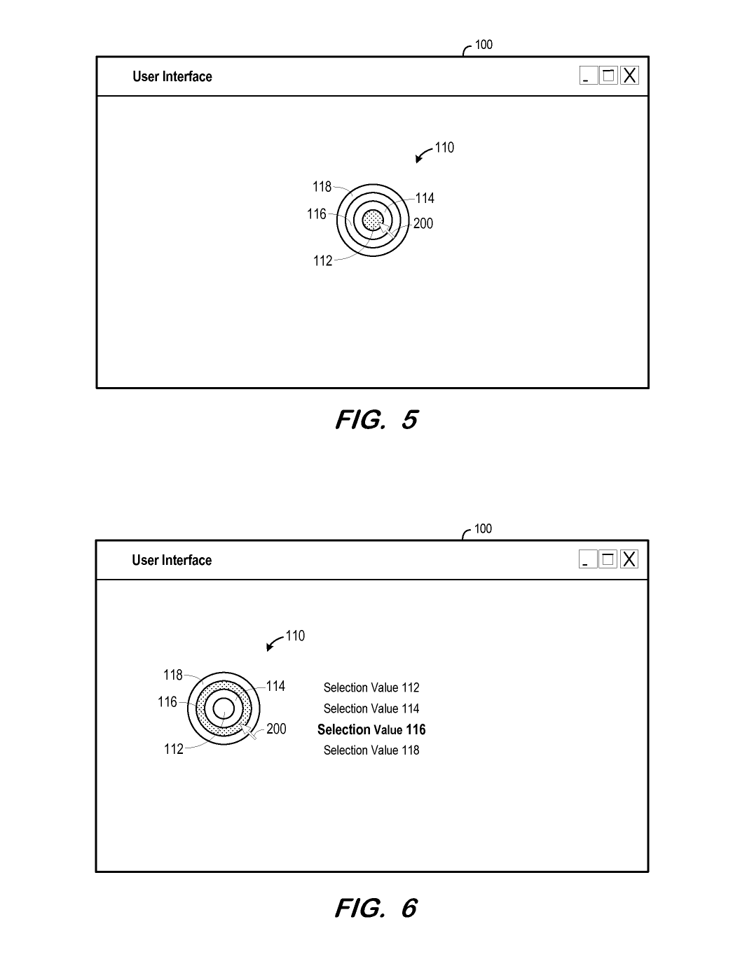

In response to the selection, a graphical indication of the selection is presented at S230. In some embodiments, the selection is replaced with a deselection. The above description with appropriate changes stands without loss of generality. According to FIG. 4, the graphical indication comprises shading of a portion of shape 116 which lies outside of circumscribed shapes 112 and 114. As an additional example, FIG. 5 illustrates selection of shape 112 and presentation of a graphical indication of this selection (i.e., shading) at S230. Embodiments are not limited to this graphical indication, and may employ any technique to visually identify the selected shape.

Embodiments are also not limited to the selection modes described above. For example, user interface control 110 may be selected “as a whole” by depressing a mouse button, for example, while a tip of arrow 200 is located on any of shapes 112-118. Such a selection may be considered a selection of a next outermost shape, according to some embodiments. In one non-exhaustive example, a first mouse-click while arrow 200 is on any of shapes 112-118 causes selection of shape 112, a next mouse-click on any of shapes 112-118 causes selection of shape 114, and yet another mouse-click on any of shapes 112-118 causes selection of shape 116. If shape 118 is currently-selected, a next mouse-click on any of shapes 112-118 may either have no effect or cause re-selection of shape 112.

According to some embodiments, the foregoing selection paradigm is reversed if the user depresses the <shift> key while depressing the mouse button. That is, each selection action results in selection of a next-innermost shape. In some embodiments, depression of an “up” arrow key results in selection of a next-outermost shape, and depression of a “down” arrow key results in selection of a next-innermost shape. Embodiments may comprise any combination of the above-described concepts.

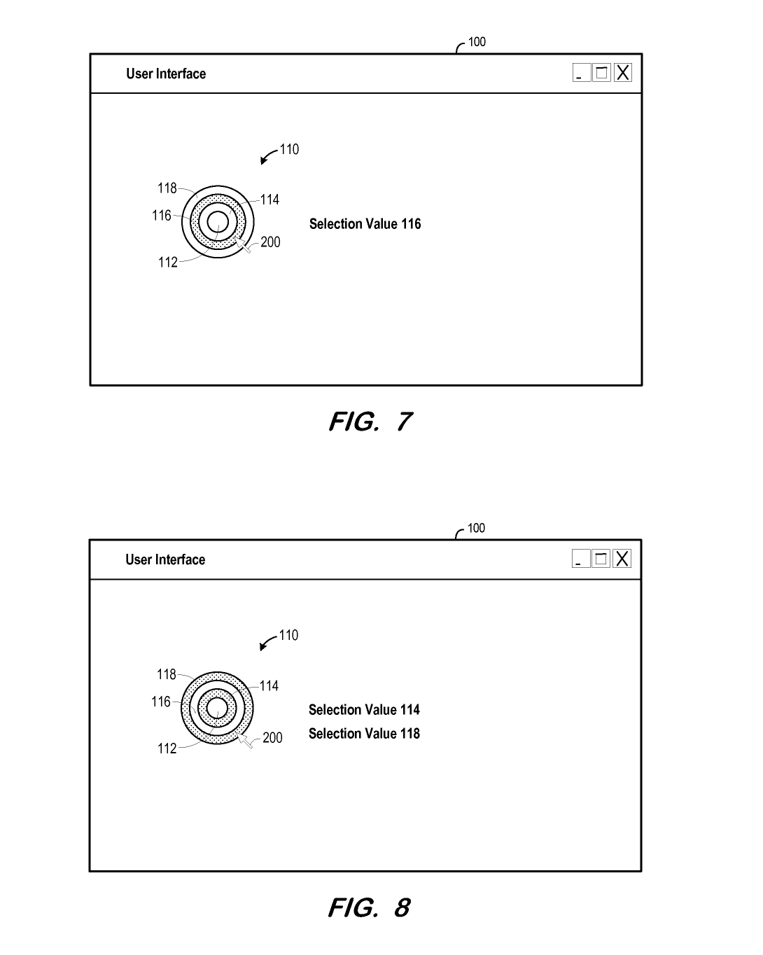

As mentioned above, each of the presented plurality of shapes is associated with a selection value. Accordingly, selection of a shape is equivalent to selecting its associated selection value. FIG. 6 illustrates an embodiment in which selection of a shape also results in presentation of a graphical indication of its associated selection value. Specifically, shape 116 is indicated as selected and its associated selection value is presented in bold. FIG. 7 depicts a similar embodiment, in which selection values associated with the non-selected shapes are not presented.

According to some embodiments, the alphanumeric text of the presented selection values may be associated with respective accelerator (i.e., hot) keys. Depressing a particular accelerator key will therefore result in selection of the shape associated with the respective selection value.

The embodiments described above are suitable for scenarios in which a user is required to select only one of several mutually-exclusive selection values. Embodiments are not, however, limited thereto. For example, FIG. 8 depicts selection of shapes 114 and 118, and presentation of their associated selection values. Shapes 114 and 118 may be selected consecutively via successive mouse-clicks, with or without accompanying depression of a <shift> or <control> key as is known in the context of multiple user interface selections.

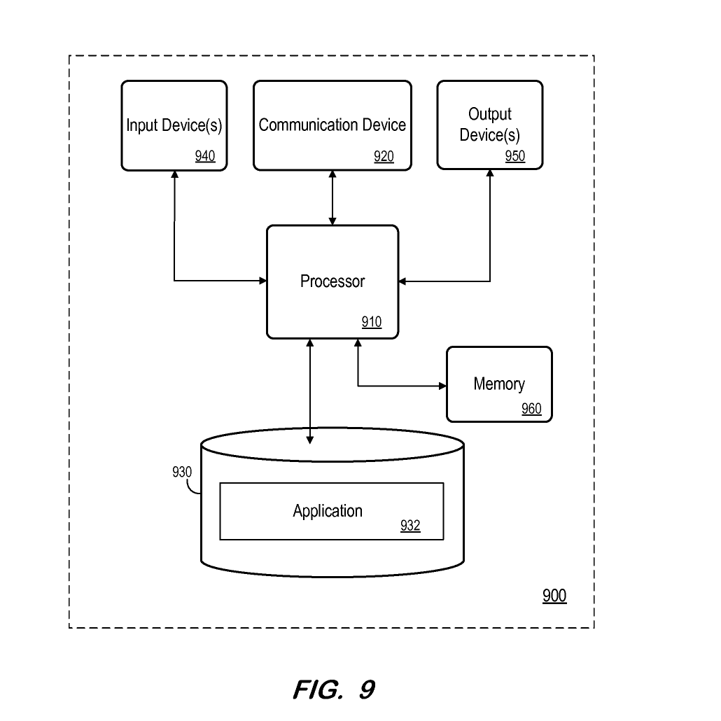

FIG. 9 is a block diagram of apparatus 900 according to some embodiments. Apparatus 900 may comprise a general-purpose computing apparatus and may execute program code to perform any of the functions described herein. Apparatus 900 may include other unshown elements according to some embodiments.

Apparatus 900 includes processor 910 operatively coupled to communication device 920, data storage device 930, one or more input devices 940, one or more output devices 950 and memory 960. Communication device 920 may facilitate communication with external devices, such as a backend enterprise computing system and/or the World Wide Web. Input device(s) 940 may comprise, for example, a keyboard, a keypad, a mouse or other pointing device, a microphone, knob or a switch, an infra-red (IR) port, a docking station, and/or a touchscreen. Input device(s) 940 may be used, for example, to enter information into apparatus 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, etc., while memory 960 may comprise Random Access Memory (RAM).

Application 932 of data storage device 930 may comprise program code executable by processor 910 to cause apparatus 900 to perform process 200 and/or any of the functions described herein. Embodiments are not limited to execution of these functions by a single apparatus. Data storage device 930 may also store data and other program code for providing additional functionality and/or which are necessary for operation thereof, such as device drivers, operating system files, etc.

Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions.

All systems and processes discussed herein may be embodied in program code stored on one or more computer-readable non-transitory media. Such non-transitory media may include, for example, a fixed disk, a floppy disk, a CD-ROM, a DVD-ROM, a Flash drive, magnetic tape, and solid state RAM or ROM storage units. Embodiments are therefore not limited to any specific combination of hardware and software.

The appended claims are not to be deemed limited solely to the embodiments described herein.

What is claimed is:

1. A method implemented by a computing system in response to execution of program code by a processor of the computing system, the method comprising:
presenting a plurality of shapes on a display, each shape associated with a selection value and one or more of the plurality of shapes being circumscribed by one or more other of the plurality of shapes;
receiving a selection of one of the plurality of shapes; and
in response to receiving the selection, presenting a graphical indication of the selection of the one of the plurality of shapes.

2. A method according to claim 1, wherein the plurality of shapes are concentric.

3. A method according to claim 2, wherein each of the plurality of shapes is a circle.

4. A method according to claim 1, wherein receiving the selection of one of the plurality of shapes comprises:
detecting a user input; and
in response to the user input, determining the one of the plurality of shapes adjacent to one of the plurality of shapes which is currently indicated as selected.

5. A method according to claim 1, wherein presenting the graphical indication of the selection of the one of the plurality of shapes in response to receiving the selection comprises:
presenting a selection value associated with the one of the plurality of shapes.

6. A non-transitory medium storing processor-executable program code, the program code executable by a device to:
present a plurality of shapes on a display, each shape associated with a selection value and one or more of the plurality of shapes being circumscribed by one or more other of the plurality of shapes;
receive a selection of one of the plurality of shapes; and
in response to receipt of the selection, present a graphical indication of the selection of the one of the plurality of shapes.

7. A medium according to claim 6, wherein the plurality of shapes are concentric.

8. A medium according to claim 7, wherein each of the plurality of shapes is a circle.

9. A medium according to claim 6, wherein the program code executable by a device to receive the selection of one of the plurality of shapes comprises program code executable by a device to:
detect a user input; and
in response to the user input, determine the one of the plurality of shapes adjacent to one of the plurality of shapes which is currently indicated as selected.

10. A medium according to claim 6, wherein the program code executable by a device to present the graphical indication of the selection of the one of the plurality of shapes in response to receipt of the selection comprises program code executable by a device to:
present a selection value associated with the one of the plurality of shapes.

11. A system comprising:
a computing device comprising:
a memory storing processor-executable program code; and
a processor to execute the processor-executable program code in order to cause the computing device to:
present a plurality of shapes on a display, each shape associated with a selection value and one or more of the plurality of shapes being circumscribed by one or more other of the plurality of shapes;
receive a selection of one of the plurality of shapes; and
in response to receipt of the selection, present a graphical indication of the selection of the one of the plurality of shapes.

12. A system according to claim 11, wherein the plurality of shapes are concentric.

13. A system according to claim 12, wherein each of the plurality of shapes is a circle.

14. A system according to claim 11, wherein receipt of the selection of one of the plurality of shapes comprises:
detection of a user input; and
in response to the user input, determination of the one of the plurality of shapes adjacent to one of the plurality of shapes which is currently indicated as selected.

15. A system according to claim 11, wherein presentation of the graphical indication of the selection of the one of the plurality of shapes in response to receipt of the selection comprises:
presentation of a selection value associated with the one of the plurality of shapes.
